(19) United States
(12) Patent Application Publication
(10) Pub. No.: US 2010/0236226 A1
(43) Pub. Date: Sep. 23, 2010

(54) Exhaust system and method for an internal combustion engine and a generator set utilizing same

(75) Inventor: William A. Eldredge, Los Altos, CA (US)

Correspondence Address: LAW OFFICES OF MICHAEL M. AHMADSHAHI, 600 ANTON BLVD., STE. 1100, COSTA MESA, CA, 92626, US

(73) Assignee: Goodman Ball, Inc.

(21) Appl. No.: 12/383,196

(22) Filed: Mar. 19, 2009

(51) Int. Cl. F01N 7/00; F01N 3/02; H02K 7/18

(52) U.S. Cl. 60/322; 60/320; 290/1 R

(57) ABSTRACT

This invention discloses an exhaust system for an internal combustion engine and a generator set utilizing same. The exhaust system reduces jet noise and temperature of a first exhaust gas from the internal combustion engine. The exhaust system comprises an inlet, a chamber, and an outlet. The inlet is capable of generating an airflow into the chamber where the first exhaust gas is merged with said airflow into a second exhaust gas, thereby reducing the noise and temperature of the first exhaust gas. The chamber includes sound absorbing material to further reduce the noise. The inlet is decoupled from the internal combustion engine to reduce vibration noise, and is made up of a high temperature elastomer to accommodate extreme exhaust gas temperatures.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

This invention is related to exhaust systems for internal combustion engines. In particular, this invention relates to a generator set, including a system and method, which comprises an internal combustion engine and a first and second exhaust system. The first exhaust system is coupled with the internal combustion engine and discharges a first exhaust gas from the internal combustion engine into the second exhaust system. The second exhaust system reduces the noise and temperature of the first exhaust gas by generating an airflow via an inlet, merging the airflow and the first exhaust gas into a second exhaust gas in a chamber, and discharging the second exhaust gas via an outlet.

### BACKGROUND

The present invention relates to a generator set comprising an internal combustion engine and a generator. A first exhaust gas from the internal combustion engine passes through a first exhaust system where the exhaust gas is treated to reduce pollutants, noise, and temperature. This invention focuses specifically on incorporating a second exhaust system that will further reduce the noise and temperature of the first exhaust gas. The second exhaust system comprises an inlet, a chamber, and an outlet. In particular, the inlet is capable of generating an airflow which merges with the first exhaust gas in the chamber to form a second exhaust gas which is subsequently discharged through the outlet. A further reduction of noise and temperature in the first exhaust gas is achieved by decoupling the inlet of the second exhaust system from the first exhaust system and including a sound absorbing material in the chamber, respectively.

Exhaust systems ordinarily are comprised of catalytic converters and mufflers/silencers. The former is used to reduce pollutants and the latter is implemented to reduce noise. Although such exhaust systems are primarily used in automobiles, they are now commonly used in other applications such as generator sets and similar equipment using internal combustion engines. As demand for engine power increases, temperature and jet noise from exhaust gas generated by such engines become a concern.

For instance, in a generator set, an engine drives a generator where the engine mechanical power is converted into electrical power. The engine and generator are installed in an enclosure having input and output ports that are coupled with the engine and generator. An input port may be used to deliver fuel to the engine and an output port may be used to expel exhaust gas generated by the engine. The enclosure may be placed in locations where personnel may come in close proximity of the output port, creating a hazardous situation. In some applications, multiple generator sets are used during the operation giving rise to excessive noise produced by the exhaust gas from individual units.

Exhaust gas temperature control becomes critical in applications where interactions between personnel and equipment are frequent. Hot gases can produce injuries to personnel where such interactions occur in close proximity. Furthermore, as the frequency of interactions increases, inadvertent contacts with such hot gases become more common. Additionally, the hot gases can become a source of fire. Therefore, an exhaust system with low exhaust gas temperature is needed.

Exhaust gas temperatures are considerably higher than the ambient temperature. This temperature gradient can be used advantageously to reduce the exhaust gas temperature from a first exhaust system. This may be accomplished by providing a second exhaust system whose inlet is capable of generating an airflow that may be mixed with the exhaust gas from the first exhaust system in a chamber, resulting in a second exhaust gas whose temperature is well below that of the first exhaust gas.

Exhaust gas jet noise control is also vital in applications where noise level must be below a threshold for stealth operation. Although mufflers/silencers, included in the engine exhaust system, reduce the noise of the engine exhaust gases, the noise level may still be too high when multiple units are used during the operation. Accordingly, a further reduction in exhaust noise level is desirable.

Multiple silencers have been utilized in more sophisticated exhaust systems in order to reduce noise. Sound canceling mufflers have also been utilized to address this issue. However, such exhaust systems are costly and may amplify/transmit vibrational noise from the first unit to the second. Such vibrational noise transmission can be eliminated by decoupling the first exhaust system from the second exhaust system, while providing the benefits of noise reduction via a secondary muffler.

Although various systems have been proposed which touch upon some aspects of the above problems, they do not provide solutions to the existing limitations in exhaust systems. For example, in Steenakers et al., U.S. Pat. No. 6,173,800, an exhaust system for a motor vehicle is disclosed where at least two casings belonging to a catalytic converter and/or silencer are connected by rigid exhaust parts, whereas in the present invention the first and second exhaust systems are substantially decoupled. In Jorg Alexnat et al., U.S. Pat. No. 6,058,702, a motor vehicle exhaust system is disclosed having a catalytic converter and one or more silencers coupled using a deformable line member with bellows for vibrational decoupling and for compensation of the lengthening of rigid exhaust parts caused during operation by the hot exhaust gas. The present invention substantially decouples the first and second exhaust system by providing a gap for a decrease in exhaust gas temperature and vibration level.

Exhaust systems, such as those incorporated in a generator set, comprise pollutant, temperature, and noise control components. However, a further reduction in the temperature and noise is required. A second exhaust system may be utilized to generate an airflow, at ambient temperature, to be mixed with the exhaust gas from the first exhaust system to form a second exhaust gas at a considerably lower temperature. A further noise reduction in the first exhaust gas from the first exhaust system also can be achieved by substantially decoupling and incorporating sound absorbing material in the second exhaust system.

### SUMMARY

The present invention discloses an exhaust system which may be used with an internal combustion engine to reduce temperature and noise of exhaust gases generated by the engine. In particular, a generator set is disclosed where the exhaust system of the present invention is utilized as a secondary exhaust system to that of the engine's primary exhaust system. The exhaust system comprises an inlet, a chamber, and an outlet. The inlet is capable of generating an airflow from the ambient air which is at a lower temperature compared to that of the exhaust gas temperature. The exhaust gas and the airflow are merged in the chamber where the temperature of the exhaust gas is reduced. Additionally, a reduction in the exhaust gas jet noise is achieved by reducing the relative speeds between the exhaust gas jet and the medium into which the former is discharged. The resulting gas in the chamber is expelled through the outlet of the exhaust system.

In one aspect an exhaust system is disclosed comprising an inlet, a chamber, and an outlet. The exhaust system operates to reduce the temperature and jet noise of an exhaust gas. The inlet receives the exhaust gas and ambient air where the two gases are merged in the chamber and expelled via the outlet. Preferably, the inlet is capable of generating an airflow by providing a favorable pressure gradient within the chamber, causing the ambient air to be drawn into it.

In another aspect an exhaust system is disclosed comprising an inlet, a chamber, and an outlet. The exhaust system operates to reduce the temperature and jet noise of an exhaust gas. The inlet receives the exhaust gas and ambient air where the two gases are merged in the chamber and expelled via the outlet. Preferably, the inlet further comprises a member that is positioned about an exhaust pipe carrying the exhaust gas, providing for an annular region between the member and exhaust pipe through which the ambient air is drawn into the chamber. Preferably, the inlet is further substantially decoupled from the exhaust pipe to prevent transfer of vibrational noise from the latter to the former.

In another aspect an exhaust system is disclosed comprising an inlet, a chamber, and an outlet. The exhaust system operates to reduce the temperature and jet noise of an exhaust gas. The inlet receives the exhaust gas and ambient air where the two gases are merged in the chamber and expelled via the outlet. Preferably, the chamber further comprises a sound absorbing material to further reduce the noise of the exhaust gas.

In another aspect a generator set is disclosed comprising an internal combustion engine, a first exhaust system, and a second exhaust system. Preferably, the first exhaust system is coupled with the engine and generates a first exhaust gas. Preferably, the second exhaust system is according to the aforementioned exhaust system, comprising a inlet, a chamber, and an outlet. Preferably, the inlet is capable of generating an airflow which is merged with the first exhaust gas. The two gases are mixed within the chamber and expelled via the outlet.

In another aspect a method for discharging exhaust gas from an internal combustion engine is disclosed. The method comprises generating an airflow and merging it with a first exhaust gas from a first exhaust system of the engine and discharging the resulting second exhaust gas at a lower temperature and noise. Preferably, the method comprises generating the airflow via an inlet of a second exhaust system, merging the first exhaust gas and the airflow in a chamber of the second exhaust system, and discharging the second exhaust gas via an outlet of the second exhaust system.

### BRIEF DESCRIPTION OF THE DRAWINGS

FIG. 1 shows a block diagram of an exhaust system for an internal combustion engine according to a preferred embodiment.

FIG. 2 is a schematic diagram of a preferred embodiment of the present invention implemented as a second exhaust system for an internal combustion engine coupled with a first exhaust system.

FIG. 3 is a schematic diagram of a preferred embodiment of the present invention implemented as a second exhaust system for an internal combustion engine coupled with a first exhaust system.

FIG. 4 is a schematic diagram of a preferred embodiment of the exhaust system according to the present invention.

FIG. 5 is a schematic diagram of a preferred embodiment of the exhaust system according to the present invention.

FIG. 6 is a schematic diagram of a preferred embodiment of an inlet of the exhaust system according to the present invention.

FIG. 7 is a flow diagram of one preferred method of operation of the exhaust system.

### DETAILED DESCRIPTION OF THE PRESENTLY PREFERRED EMBODIMENTS

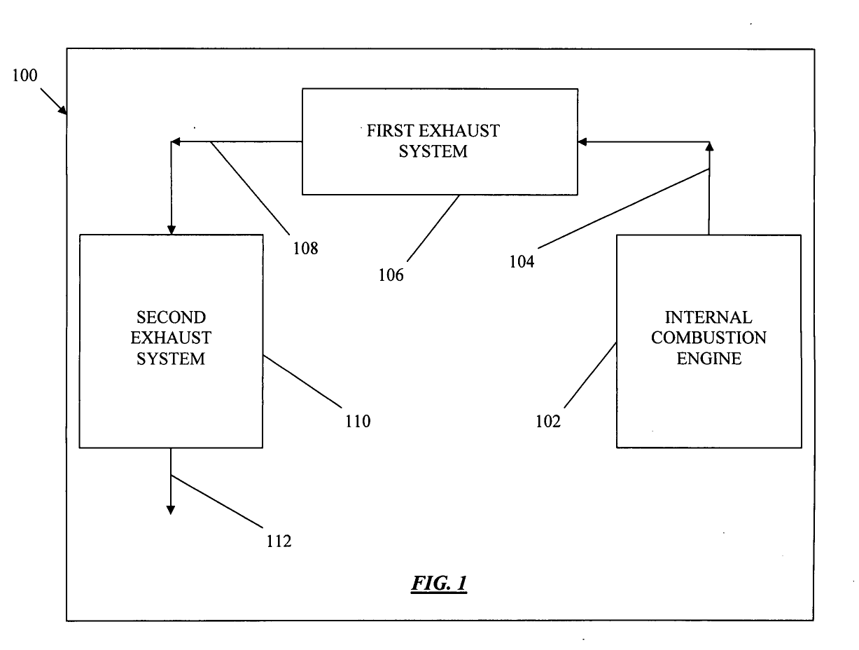

FIG. 1 depicts a block diagram of a preferred embodiment of an exhaust system for an internal combustion engine 100 according to the present invention. According to this embodiment, the system 100 comprises an internal combustion engine 102, a first exhaust system 106, and a second exhaust system 110. The present embodiment may be implemented in a generator set where the engine 102 is coupled with a generator (not shown) and installed within an enclosure (not shown). The exhaust gases 104 from the engine 102 pass through the first exhaust system 106 and a first exhaust gas is expelled at 108. The first exhaust gas 108 is at a high temperature and would ordinarily discharge into the air within the enclosure. The jet noise generated by such discharge is also at a high level. This is due to the fact that the air within the enclosure is at rest while the first exhaust gas 108 is discharged at a finite speed. The second exhaust system 110 receives the first exhaust gas 108 via an inlet (discussed below) capable of generating an airflow that is mixed with the first exhaust gas 108 within a chamber (discussed below) of the second exhaust system 110, forming a second exhaust gas 112 which is discharged via the latter's outlet (discussed below). Since the first exhaust gas 108 merges with the airflow, generated by the second exhaust system 110 and traveling at approximately the same speed of the first exhaust gas 108, a reduction in the jet noise of the first exhaust gas 108 is achieved. Additionally, since the airflow is at a lower temperature, i.e., ambient temperature, the second exhaust gas 112 has a lower temperature than that of the first exhaust gas 108.

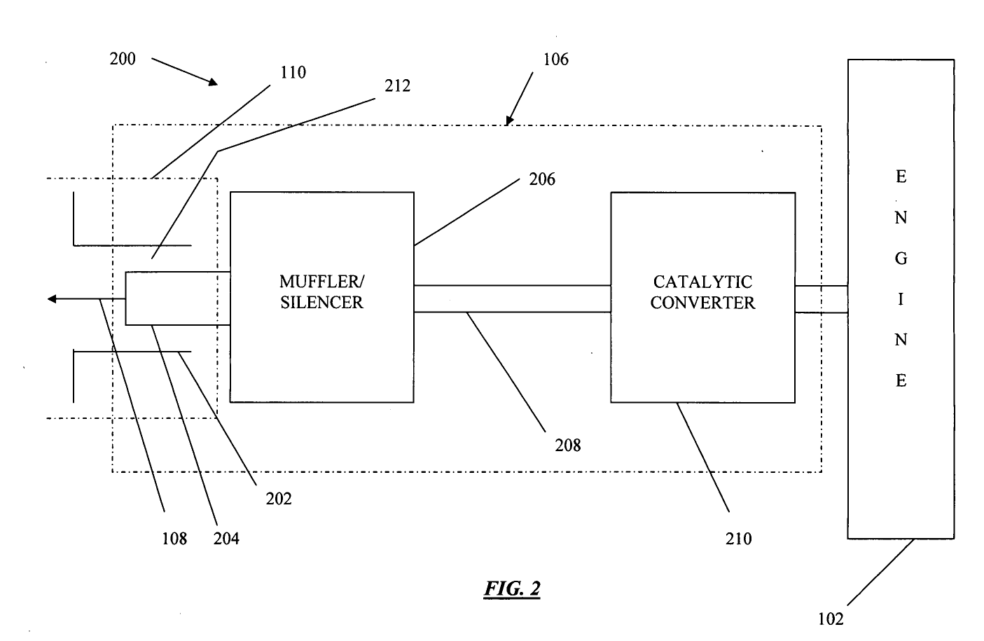

According to one embodiment, depicted in FIG. 2, the first exhaust system 106 comprises a catalytic converter 210 coupled with a muffler/silencer 206 via a connecting pipe 208. According to this embodiment, the muffler/silencer 206 further comprises an exhaust pipe 204 where the first exhaust gas 108 is discharged. The inlet 202 of the second exhaust system 110 is disposed about the exhaust pipe 204 without making contact with the latter. This arrangement provides for an annular region 212 where an airflow is generated which merges with the first exhaust gas 108 to reduce its temperature, and prevents transfer of vibration from the exhaust pipe 204 to the second exhaust system 110.

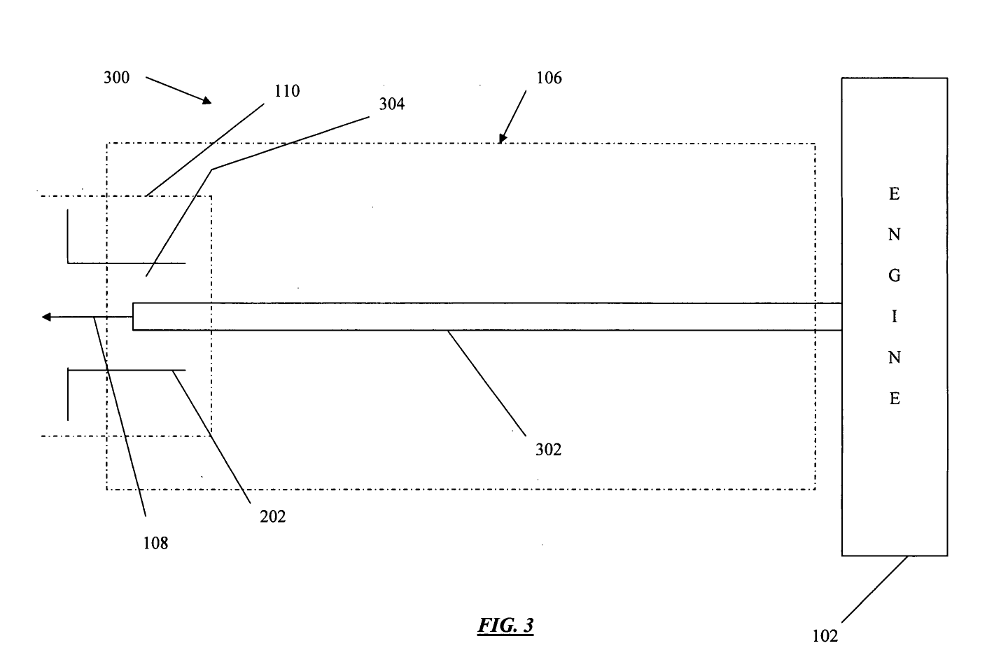

According to another embodiment, depicted in FIG. 3, the first exhaust system 106 consists only of an exhaust pipe 302 through which the first exhaust gas 108 is discharged. The exhaust pipe 302 is similarly located about the inlet 202 of the second exhaust system 110. As in the previous embodiment, this arrangement provides for a reduction in temperature and noise of the first exhaust gas 108, by providing airflow through the annular region while decoupling from the first exhaust system.

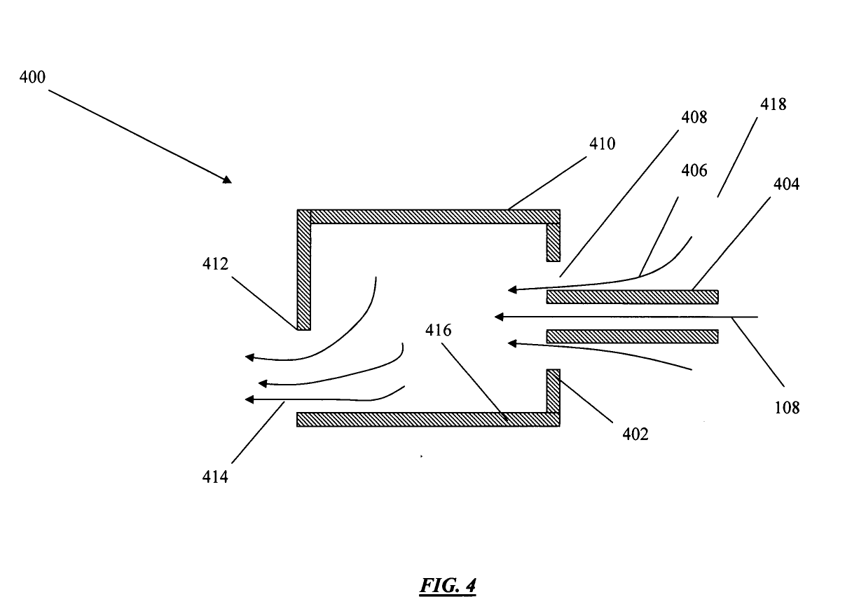

FIG. 4 depicts a schematic diagram of a preferred embodiment of the exhaust system 400 according to the present invention. According to this embodiment, the exhaust system 400 comprises an inlet 402, a chamber 410, and an outlet 412. The first exhaust gas 108 generated by the engine 102 is discharged through an exhaust pipe 404 into the chamber 410. An annular region 408 between the inlet 402 and the exhaust pipe 404 facilitates passage of ambient air 418 through the annular region 408 and into the chamber 410. The first exhaust gas 108 is mixed with the ambient air 418 inside the chamber 410 wherein the temperature of the first exhaust gas 108 is reduced by mixing with the ambient air 418 which is at a lower temperature. The resulting second exhaust gas 414 is discharged via the outlet 412.

The speed of the first exhaust gas 108 provides for a lower pressure inside the chamber 410 causing the ambient air 418 to be drawn into the chamber 410. As discussed above, this mixing of the ambient air 418 and the first exhaust gas 108 lowers the temperature of the latter. Additionally, the jet noise generated by the first exhaust gas 108 is reduced since it is discharged into a moving stream 406 of the ambient air 418. It should also be clear to a skilled artisan that the ambient air is not limited to atmospheric air at rest, but that it can be conditioned to have a higher pressure and speed. For instance, the ambient air could be blown into the enclosure by a blower, such as a fan.

Decoupling the exhaust pipe 404 from the exhaust system 400 eliminates vibrational noise transfer of the exhaust pipe 404 and the first exhaust gas 108 to the exhaust system 400. The exhaust pipe 404 vibrates due to the vibration of the engine 102. The exhaust pipe 404 further vibrates due to the passage of the first exhaust gas 108. Positioning the exhaust pipe 404 within the inlet 402 without making contact with the exhaust system 400 prevents these vibrations to be transferred to the latter. Furthermore, the exhaust pipe 404 is at a high temperature due to the temperature of the first exhaust gas 108 and engine 102. Such decoupling of the exhaust pipe 404 and the exhaust system 400 prevents heat transfer between the former and the latter, thus, maintaining the temperature of the exhaust system 400 lower than the exhaust pipe 404.

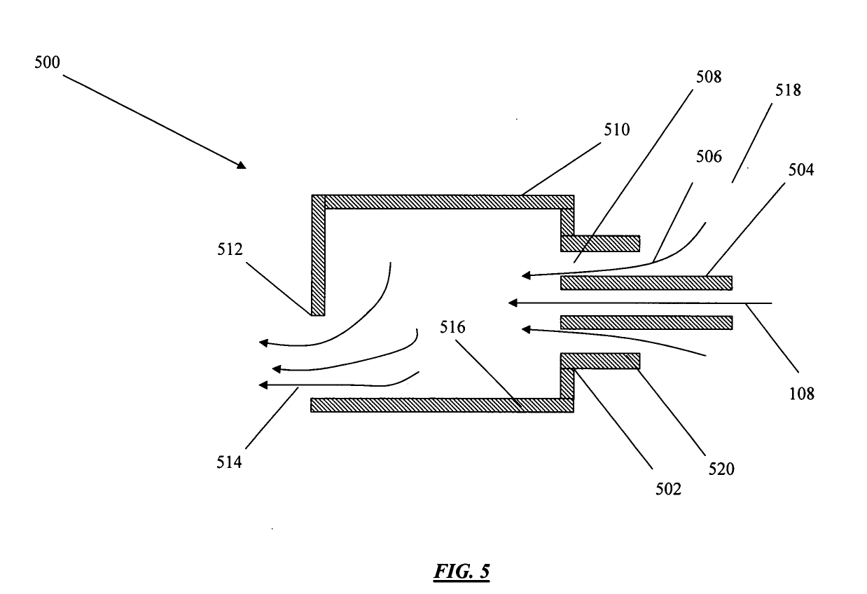

FIG. 5 depicts a schematic diagram of a preferred embodiment of the exhaust system 500 according to the present invention. According to this embodiment, the exhaust system 500 comprises an inlet 502, a chamber 510, and an outlet 512. As discussed above, the exhaust gas 108 is discharged into the chamber 510 through an exhaust pipe 504. According to this embodiment, the inlet 502 comprises a member 520 which is disposed about the exhaust pipe 504. An annular region 508, formed between these two components, facilitates passage of ambient air 518 into the chamber. As discussed above, the exhaust gas 108 mixes with the ambient air 518 inside the chamber 510 to form a second exhaust gas 514 which is discharged through the outlet 512.

According to one variation of the present embodiment, the member 520 is a cylindrical member which may be constructed out of an elastomeric, metallic, or ceramic material. The member 520 may be secured to the inlet 502 in any manner feasible and know to skilled artisans. For instance fasteners such as bolts and pins, press, or shrink fit can be utilized to attach the member 520 to the inlet 502. An annular region, formed between the member 520 and the exhaust pipe 504 provides for a favorable pressure gradient that draws ambient air 518 into the chamber 510 in the form of airflow 506. According to another variation of the present embodiment, the member 520 is simply an extension of the inlet 502 in the form a protrusion.

The annular region 508 between the member 520 and the exhaust pipe 504 may be adjusted by adjusting the thickness of the member 520. The gap created between the member 520 and the exhaust pipe 504 can be selected according to the operating conditions, namely, the speed of the first exhaust gas 108. Different gap sizes provides for different aerodynamic conditions affecting the airflow 506. Accordingly, the performance of the exhaust system 500, with respect to temperature and noise reduction of the first exhaust gas 108, can easily be optimized.

According to another preferred embodiment, the chamber 510 comprises a cubical member. Other shapes, such as cylindrical could be used according to spatial constraints of the enclosure. The chamber 510 may further comprise one or more openings in the form of a louver or a vent, wherein the ambient air 518 is further drawn in to the chamber 510.

According to another preferred embodiment, the chamber 510 further comprises sound absorbing material such as sound absorbing foam known to skilled artisans. This provides for additional reduction in the jet noise from the first exhaust gas 108. In one instance, a sound absorbing foam that can withstand high temperatures may be utilized under severe conditions, such as that disclosed in the U.S. Pat. No. 5,777,947 by Ahuja. In another instance, the sound absorbing material is a perforated fiberglass.

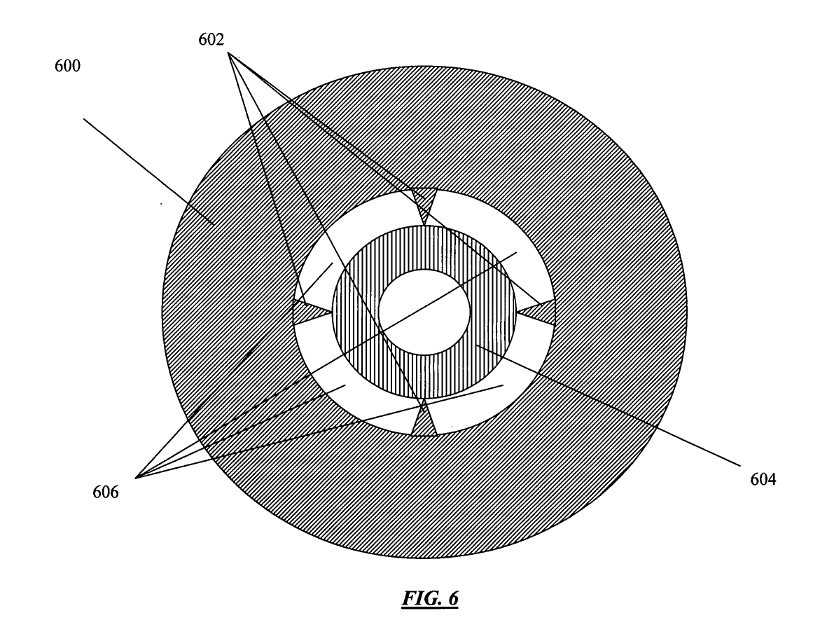

According to another preferred embodiment, depicted in FIG. 6, the inlet 600 comprises one or more spokes 602. The pokes 602 may be utilized to hold an exhaust pipe 604. According to this embodiment, the inlet 600 can provide support for the exhaust pipe 604 while providing for an annular gap 606, wherein ambient air may be drawn into the chamber.

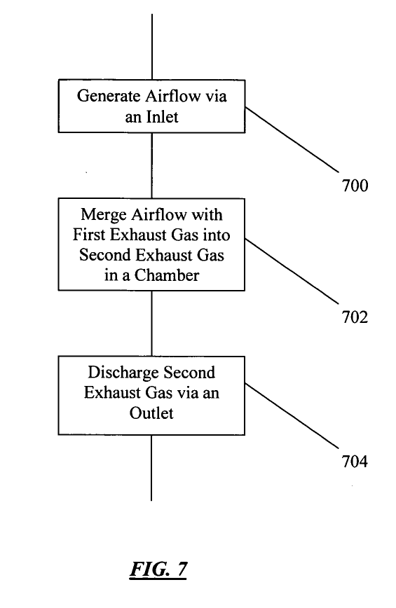

FIG. 7 illustrates an example of one method for discharging exhaust gas from an internal combustion engine. According to this method, a first exhaust gas from an internal combustion engine is discharged by generating an airflow via an inlet at 700, merging the air flow with the first exhaust gas in a chamber to form a second exhaust gas at 702, and discharging the second exhaust gas via an outlet at 704. This method may be implemented to discharge exhaust gas from an internal combustion engine in a generator set. As discussed above, the airflow can be generated from ambient air which may be at atmospheric pressure and at rest, or at a higher pressure and speed.

As discussed above, by generating the airflow, temperature and noise of the first exhaust gas can be reduced. By further decoupling the inlet from an exhaust pipe belonging to a first exhaust system coupled with the engine, a further reduction in noise and temperature is achieved. The noise can further be decreased by implementing sound absorbing elements in the chamber of the exhaust system of the present invention.

The forgoing discloses an exhaust system comprising an inlet, a chamber, and an outlet, whereby exhaust gas from an internal combustion engine may be mixed with an airflow, generated via the inlet, inside the chamber and discharged through the outlet. The inlet provides for a favorable pressure gradient that draws ambient air into the chamber reducing the temperature and noise of the exhaust gas. Additional noise reduction can be achieved by incorporating a chamber that comprises sound absorbing material.

The foregoing explanations, descriptions, illustrations, examples, and discussions regarding this invention have been set forth to assist the reader with understanding this invention and to demonstrate the utility and novelty of it and are by no means restrictive of its scope. It is the following claims, including all equivalents, which are intended to define the scope of this invention.

What is claimed is:

1. An exhaust system for an internal combustion engine, said exhaust system comprising:
(a) an inlet capable of generating an airflow;
(b) a chamber coupled with the inlet and capable of receiving a first exhaust gas from the internal combustion engine and the airflow via the inlet; and
(c) an outlet coupled with the chamber;
wherein the chamber reduces at least one of a noise and a temperature of the first exhaust gas by merging the first exhaust gas and the airflow into a second exhaust gas in said chamber and discharging the second exhaust gas via the outlet.

2. The exhaust system of claim 1, wherein the inlet comprises a member disposed about an exhaust pipe of the internal combustion engine, thereby providing an annular region between said member and the exhaust pipe.

3. The exhaust system of claim 2, wherein the member comprises a cylindrical member.

4. The exhaust system of claim 2, wherein the member is substantially decoupled from the exhaust pipe.

5. The exhaust system of claim 2, wherein the member comprises at least one of an elastomeric element, a metallic element, and a ceramic element.

6. The exhaust system of claim 5, wherein said elastomeric element is a silicone rubber.

7. The exhaust system of claim 1, wherein the inlet comprises one or more spokes disposed about an exhaust pipe of the internal combustion engine, thereby providing an annular region between said member and the exhaust pipe.

8. The exhaust system of claim 1, wherein the chamber comprises a cubical member.

9. The exhaust system of claim 1, wherein the chamber further comprises at least one of a louver and a vent.

10. The exhaust system of claim 1, wherein the chamber comprises a sound absorbing element.

11. The exhaust system of claim 10, wherein the sound absorbing element comprises at least one of a sound absorbing foam and perforated fiberglass.

12. A generator set comprising:
(a) an internal combustion engine;
(b) a first exhaust system coupled with the internal combustion engine and capable of discharging a first exhaust gas from the internal combustion engine via a first exhaust pipe; and
(c) a second exhaust system comprising an inlet, a chamber, and an outlet;
wherein the second exhaust system receives the first exhaust gas from the first exhaust pipe and an airflow via the inlet, merges the first exhaust gas and the airflow into a second exhaust gas in the chamber thereby reducing at least one of a noise and a temperature of the first exhaust gas, and discharges the second exhaust gas via the outlet.

13. The generator set of claim 12, wherein the inlet comprises a member disposed about the exhaust pipe, thereby providing an annular region between said member and the exhaust pipe.

14. The generator set of claim 13, wherein the member is substantially decoupled from the exhaust pipe.

15. The generator set of claim 12, wherein the inlet comprises one or more spokes disposed about an exhaust pipe of the internal combustion engine, thereby providing an annular region between said member and the exhaust pipe.

16. The generator set of claim 12, wherein the chamber comprises a sound absorbing element.

17. A generator set comprising:
(a) an internal combustion engine; and
(b) an exhaust system comprising an inlet, a chamber, and an outlet;
wherein the exhaust system receives a first exhaust gas from the internal combustion engine and an airflow via the inlet, merges the first exhaust gas and the airflow into a second exhaust gas in the chamber thereby reducing at least one of a noise and a temperature of the first exhaust gas, and discharges the second exhaust gas via the outlet.

18. The generator set of claim 17, wherein the inlet comprises an element disposed about an exhaust pipe of the internal combustion engine, thereby providing an annular region between said member and the exhaust pipe.

19. A method for discharging exhaust gas from an internal combustion engine, comprising:
(a) generating an airflow via an inlet;
(b) merging the airflow and a first exhaust gas from the internal combustion engine into a second exhaust gas in a chamber coupled with the inlet; and
(c) discharging the second exhaust gas via an outlet coupled with the chamber.

20. The method of claim 19, wherein the inlet comprises a member disposed about an exhaust pipe of the internal combustion engine and wherein (a) comprises creating a negative pressure zone in an annular region between the member and the exhaust pipe.

21. The method of claim 20, further substantially decoupling the member from the exhaust pipe.

22. The method of claim 19, further absorbing noise from the first exhaust gas via a sound absorbing element in the chamber.

23. A method for discharging exhaust gas from an internal combustion engine included in a generator set, said generator set comprising a first and second exhaust systems, said first exhaust system coupled with the internal combustion engine and comprising a first exhaust pipe, said second exhaust system comprising an inlet, a chamber, and an outlet, said method comprising:
(a) generating an airflow via the inlet;
(b) merging the airflow and a first exhaust gas from the first exhaust pipe into a second exhaust gas in the chamber; and
(c) discharging the second exhaust gas via the outlet.
